(19) United States
(12) Patent Application Publication
(10) Pub. No.: US 2017/0075184 A1
(43) Pub. Date: Mar. 16, 2017

(54) TWO PARTICLE TOTAL INTERNAL REFLECTION IMAGE DISPLAY

(71) Applicant: CLEARink Displays, Inc., Fremont, CA (US)

(72) Inventors: Shon LOW, Vancouver (CA); Anthony E. PULLEN, Tucson, AZ (US)

(21) Appl. No.: 15/310,722

(22) PCT Filed: May 12, 2015
(86) PCT No.: PCT/US2015/030349

§ 371 Date: Nov. 11, 2016

Related U.S. Application Data
(60) Provisional application No. 61/992,095, filed on May 12, 2014.

(51) Int. Cl. G02F 1/167; G02F 1/1362

(52) U.S. Cl. CPC G02F 1/167; G02F 1/1362; G09G 3/344

(57) ABSTRACT

A totally internally reflective image display having a first electrically charged particle and a second electrically charged particle of opposite charges are disclosed. By applying a non-zero voltage the particles are moved such that they frustrate total internal reflection and create a dark state. By applying a zero voltage and/or voltage pulsing, light is totally internally reflected to create a light state. The display is DC balanced and compatible with common drive electronics. Multi-colored displays may be created using first and second particles with different optical characteristics.

The instant application claims the filing-date benefit of U.S. Provisional Application No. 61/992,095, filed on May 12, 2014, and application Serial No. PCT Application No. PCT/US2015/030349 filed, May 12, 2015. The entirety of both applications are incorporated herein by reference.

### FIELD

The disclosure generally relates to frustration of Total Internal Reflection (TIR) in high brightness, wide viewing angle displays. Specifically, an embodiment of the disclosure relates to a direct current (DC) balanced totally internally reflective display comprising of oppositely-charged particles.

### BACKGROUND

Typically, light modulation in conventional total internal reflection (TIR) image displays is controlled by movement of electrophoretically mobile particles into and out of the evanescent wave region at the surface of the front sheet. The front sheet may comprise of a plurality of structures such as convex protrusions capable of total internal reflection of light. The front sheet typically further contains a transparent electrode layer. The rear sheet may include a rear electrode layer. An electrophoretic medium consisting of electrophoretically mobile particles suspended in a fluid is disposed between the front and rear sheets. An applied voltage moves the electrophoretically mobile particles through the electrophoretic medium. Typically the particles have either a positive or negative charge with a single optical characteristic.

As the particles are electrophoretically moved to the front or rear electrode during operation of the display, the display may be operating in a direct current (DC) unbalanced mode. At the opposite or counter electrode, applied voltages of opposite polarity can potentially lead to degradation of the display components thus shortening the life of the display and detracting from user experience.

### BRIEF DESCRIPTION OF DRAWINGS

These and other embodiments of the disclosure will be discussed with reference to the following exemplary and non-limiting illustrations, in which like elements are numbered similarly, and where:

FIG. 1A schematically illustrates a reflective image display containing oppositely-charged particles in the dark state;

FIG. 1B schematically illustrates a reflective image display containing oppositely-charged particles in the bright state;

FIG. 1C schematically illustrates a reflective image display containing oppositely-charged particles in the dark state;

FIG. 2 is a graphical representation of operation of a display depicted in FIG. 1(A-C) in accordance with one embodiment of the disclosure;

FIG. 3 schematically illustrates a method to create voltage bias dependent dark, grey and bright states;

FIG. 4 schematically illustrates a method to create voltage bias dependent dark, grey and bright states;

FIG. 5A schematically illustrates a reflective image display having charged particles of different optical characteristics in a first optical state;

FIG. 5B schematically illustrates a reflective image display having charged particles of different optical characteristics in the light state;

FIG. 5C schematically illustrates a reflective image display having charged particles of different optical characteristics in a second optical state; and

FIG. 6 is an exemplary method according to an embodiment of the disclosure.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

In certain embodiments, the disclosure provides a DC balanced, two-particle TIR image display. Electrophoretically mobile particles of opposite charge with substantially identical motilities and substantially identical optical characteristics (i.e., color) are employed to frustrate TIR to create a light absorbing or dark state by application of a non-zero voltage bias.

In certain embodiments, the term DC balanced may denote having substantially the same charge on two or more opposing electrodes. Thus, if one moves particles to the front electrode, another particle (or particles) must move to the oppositely-charged electrode to balance the charge. In the single-particle displays, only one particle is moved from one electrode to the other at any one time and as a function of how the electrodes are biased. In certain embodiments of the disclosure two (or more) particles are moved as a function of how the electrodes are biased.

In certain embodiments, the optical characteristic of the particles may be defined as the color of the particle. The color may be perceptible to the naked eye viewing the display. The terms optical characteristic and color may be used interchangeably. The color or optical characteristics of a particle may be the result of the light absorption and reflection properties of the particles. Other optical characteristics of a particle may be used without departing from the disclosed principles.

In certain embodiments, a DC balanced display may include a display where attracting electrophoretically mobile particles of a first charge to one electrode may also attract oppositely-charged electrophoretically mobile particles to the opposite electrode. Applications of a non-zero voltage bias may move one or more of the oppositely-charged particles to opposite electrodes. In certain embodiments, DC balancing may not cause a change in the optical state if the oppositely-charged particles are of substantially the same optical characteristic or color.

In an exemplary implementation, upon application of 0V between the electrodes, both species of particles are moved from the evanescent wave region of the front surface of the display. This prevents frustration of total internal reflection (TIR) and creates a bright or white state of the display. The bright state may also be referred to as the light state of the display. A continuum of grey states may be achieved by application of a continuum of voltages. The continuum of voltages may be configured to be between the light and dark states. Furthermore, the DC balanced system described herein may be directly compatible with existing driving electronics utilized in LCD-based (or other similar) display systems. This may prevent costly investment in the development of suitable drive electronics required for single particle TIR image displays. Additionally, multi-colored display embodiments using the disclosed principles are also described herein.

It should be noted that while the exemplary embodiments are discussed in relation with a display having two types of charged particles (negatively charged and positively charged particles), the disclosed principles are not limited thereto. Additional embodiments which provide substantially a balanced charge within the display may be formed to include more than two types of charged particles (e.g., particles having stronger and weaker charges which in accumulation, balances the total charge).

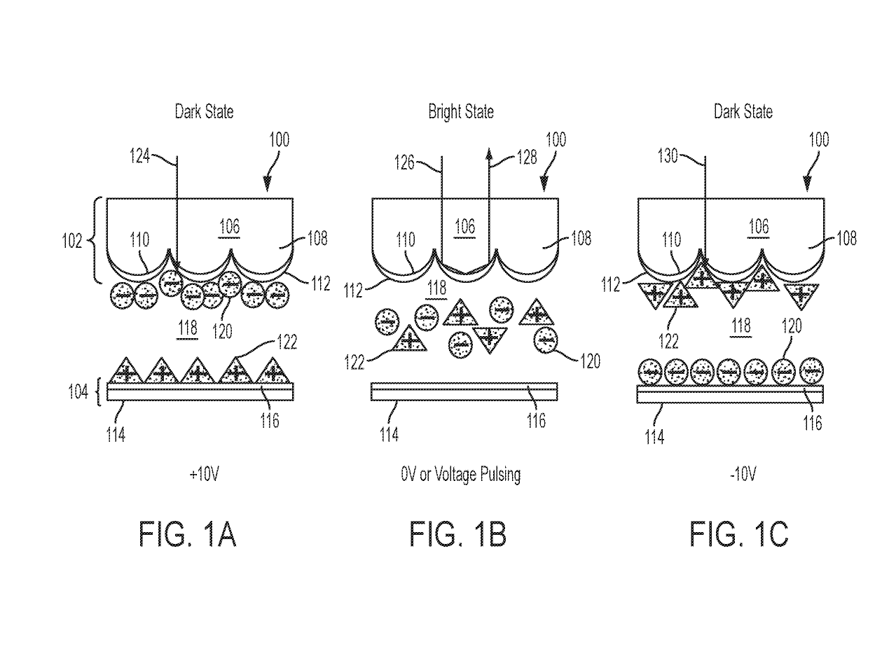

FIGS. 1A-1C depicts a portion of a reflective image display containing oppositely-charged particles in various states of operation. Specifically, the embodiments of FIGS. 1A-1C schematically illustrate a DC balanced TIR-based display system containing a plurality of positively charged particles and a plurality of negatively charged particles. The charged particles are marked as negative and positive particles for ease of reference. The particles may have substantially the same or similar optical characteristic (e.g., color). In one embodiment of the disclosure, the magnitude of the electrophoretic mobility, the diffusivity, the diameter and the light absorption cross section would be substantially similar for both the positive and negative particles. Such embodiments enable a substantially similar image response for both polarities, thereby ensuring that the amount of light absorption would vary similarly given the magnitude of the applied voltage for both polarities of the same voltage.

Referring to FIGS. 1A-1C, display 100 includes top assembly 102 and bottom assembly 104 separated by a gap or cavity. The top assembly includes front sheet 106 comprising at least one surface structure such as a convex or hemispherical protrusion 108. Hemispherical protrusions 108 form a contoured surface capable of total internal reflection of light rays. The convex portion may define a structure configured to concentrate the plurality of negatively or positively charged particles at one or more regions of the display. In another embodiment, the convex portion may further define a structure configured to substantially uniformly distribute the plurality of negatively or positively charged particles over the surface of the front sheet.

The top assembly further includes a front transparent electrode layer 110 that may be positioned on the surface of the hemispherical array 108. Transparent electrode layer 110 may include indium tin oxide (ITO), or a thin layer of metallic nanowires (such as silver), or an electrically conducting polymer or a combination thereof.

Top assembly 102 may further include dielectric layer 112 positioned over front electrode layer 110. Dielectric layer 112 may include organic material such as a polymer, an inorganic material or a combination thereof. The parylene-based family of polymers may be used in the dielectric layer. In one embodiment, the dielectric layer is approximately conformal and pin-hole free.

In the embodiment of FIGS. 1A-1C, bottom assembly 104 in display 100 includes backplane 114 with top electrode layer 116 which acts as the rear electrode. Electrode layer 116 may include a thin film transistor (TFT) array, direct drive array or patterned array of electrodes. Electrode layer 116 may be made of a metal, such as copper, aluminum, gold or silver. Electrode layer 116 may be made of electrically conductive particles, such as nanowires or nanoparticles, in a polymer matrix. Though not shown, the dielectric layer may optionally be applied to the rear electrode to protect the rear electrode layer and substantially eliminate particle sticking.

Liquid medium 118 with a low refractive index is placed in the gap or cavity formed between dielectric layer 112 and rear electrode layer 116. Liquid medium 118 can receive a plurality of dispersed light absorbing negatively charged particles 120 and a plurality of dispersed light absorbing positively charged particles 122. The low refractive index medium may be include a fluorinated liquid such as Fluorinert™ FC-770, FC-43, FC-75, Novec™ 649 or 7500.

Particles 120 and 122 are capable of being electrophoretically moved by application of an electric field across the medium 118 by an external voltage source (not shown). Particles 120, 122 may be made of an organic material or an inorganic material or a combination of an organic and inorganic material. In an exemplary embodiment, the oppositely-charged particles may have substantially the same light absorbing optical characteristics and properties.

Upon application of a positive voltage bias (e.g., +10V) for a sufficient duration (e.g, 5-10 ms), for example, as depicted in FIG. 1A at the front electrode layer 110, negatively charged particles 120 are attracted to the front electrode 110. TIR is frustrated leading to a decrease in relative reflectance while the positively charged electrophoretically mobile particles 122 are attracted to and move towards the rear electrode layer 116. Incident light rays such as representative light ray 124 are absorbed by the negatively charged particles located at the front dielectric layer 112 thus creating a dark state of the image display. Additionally, display 100 may be operating in a DC balanced mode. The cumulative positive and negative voltage times driving the negatively and positively charged light absorbing particles, respectively, is substantially the same in the display device during image sequencing.

In conventional electrophoretic displays, image sequence may control the driving sequence. Some image sequences may not allow balanced positive and negative driving times. As a result, polarization may build up within the display device which can interfere with the subsequent image quality. The disclosed embodiments overcome this and other shortcomings by allowing the image sequence to be decoupled from the driving sequence such that a DC balanced driving sequence can be used for any image sequence.

FIG. 1B illustrates application of 0V (not shown) which results in a bright or white state of the display (also may be referred to as the light state). At 0V, the negatively charged electrophoretically mobile particles 120 are moved away from the evanescent wave region near the front electrode 110, thus allowing total internal reflection of light rays to occur at the surface of the plurality of hemi-spherical protrusions 108 leading to a light state of the image display. In FIG. 1B, TIR is illustrated by incident light ray 126 being totally internally reflected as light ray 128 is semi-retro-reflected back towards the light source. Additionally, FIG. 1B shows positively charged particles 122 moved away from rear electrode 116.

In still another embodiment, a bright or white state of the display may be created and maintained by so-called voltage pulsing. Firstly, the electrophoretically mobile particles 120 will need to be moved out of the evanescent wave region by application of an appropriate voltage. For example, suppose display 100 is in the state depicted in FIG. 1A; that is, charged particles are aligned with electrodes 110 and 116. Further suppose that upon application of +10V bias at rear electrode layer 116 and −10V bias at the front electrode layer 110, it takes about 20 ms for the positively charged particles 122 to travel from rear electrode 116 to front electrode 110. Suppose also that it takes about 20 ms for the negatively charged particles 120 to travel from front electrode layer 110 to the rear electrode layer 116. A first application of about +10V at the rear electrode and −10V at the front electrode for a duration of about 10 ms would move negatively charged particles 120 out of the evanescent wave region and about mid-way between the front and rear electrodes. This creates a white or bright state of the display as a result of TIR of incident light rays. Secondly, a stable bright state of display 100 may be maintained by subsequent voltage pulsing of alternating voltages of opposite polarity for short durations of time.

For example, an exemplary voltage pulsing method may apply +5V for 5 ms, then −5V for 5 ms. The pulsing method may continue for a specified duration of time. Pulse lengths may vary for different lengths of time depending on the application and desired outcome.

In another exemplary embodiment, a pulse length of at least about one nanosecond may be used. A rest of varying lengths of time may be employed between each pulse to save energy. A non-limiting variety of pulse voltages of different polarity, voltage magnitude, voltage pulse time durations and rest times may also be used depending on the display, viscosity of medium 118, the gap distance between front and rear electrodes, magnitude and concentration of charge on the particles, particle mobility, and the desired application.

FIG. 1C shows the subsequent dark state of the device of FIG. 1A. When applying a negative voltage bias, such as −10V, at front electrode 110 as shown in FIG. 1C, positively charged particles 122 are attracted to, and move towards, front electrode 110. In this state, particles 122 collect near the hemispherical surface such that the particles enter the evanescent wave region and frustrate TIR. This results in a light absorbing dark state of the image display. The light-absorbing dark state is illustrated in FIG. 1C by incident light ray 130 being absorbed by the light absorbing positively charged particles 122. As schematically illustrated in FIG. 1C, negatively charged particles 120 are attracted to rear electrode 116. When applying a non-zero voltage (e.g., +10V or −10V) of sufficient duration across medium 118 as shown in FIGS. 1A and 1C, particles are attracted to the front and rear electrode layers. The particle attraction results not only in frustration of TIR which leads to the dark state of the image display, but also a DC balanced display.

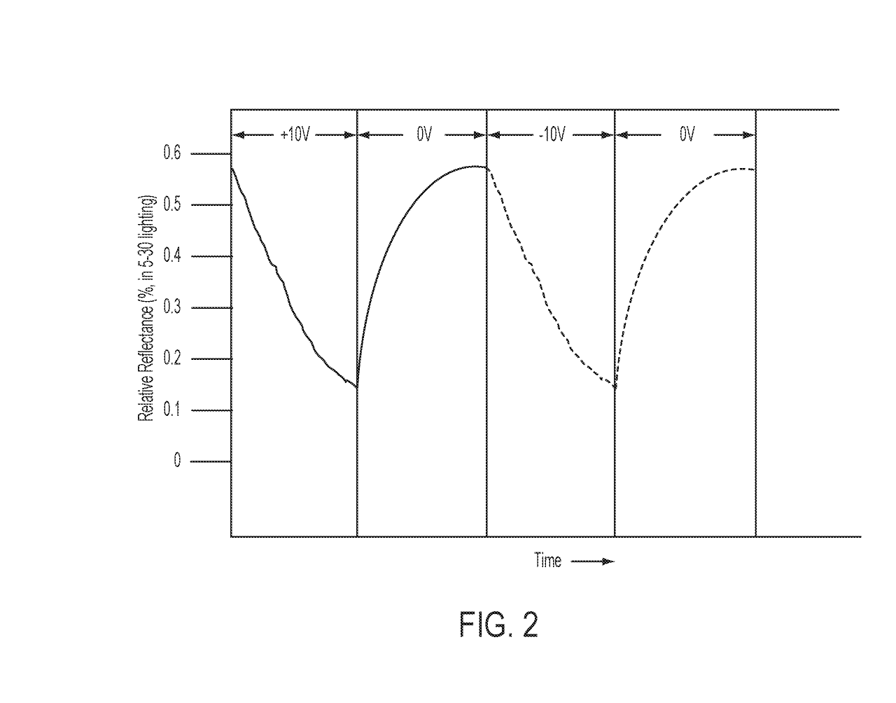

FIG. 2 graphically illustrates the relationship between the relative reflectance of the display of FIG. 1(A-C). Specifically, FIG. 2 illustrates the voltage bias dependence of total internal reflection and absorption of light of a two particle TIR-based display having both positively and negatively charged particles. In FIG. 2, the x-axis is the time during which the measurement was carried out and the y-axis is the measured resulting relative reflectance. The reflectance measurement may be taken in a dark room with a ring light illuminating the sample from about 5 degrees to about 30 degrees relative to the normal to the surface of the sample in such a way that the specular ray is masked out. A reflectance standard such as Labsphere Spectralon SRS-99-020, AS-01161-060 may also be used as a baseline for the brightness. A luminance meter, such as a Topcon BM-9, may be used to measure the reflectance.

Upon applying +10V at front electrode 110 and across liquid medium 118, the relative reflectance decreases (FIG. 2, solid line under the +10V heading). This is a result of negatively charged particles 120 being attracted to the front electrode and dielectric layers adjacent the surface of the plurality of hemispherical protrusions. Here, TIR is frustrated as negatively charged particles 120 enter the evanescent wave region of display 100 (see FIG. 1A). When 0V, or a negative voltage bias of a specified pulse time followed by voltage pulsing is applied, negatively charged particles 120 of FIG. 1A move out of and away from the evanescent wave region where TIR of incident light rays lead to a light state. The relative reflectance increases (solid line under the 0V heading) as shown in FIG. 2. Applying a negative voltage bias at the front electrode such as −10V moves positively charged particles 122 towards front electrode 110 and adjacent the hemispheres where TIR is frustrated to thereby decrease relative reflectance (FIG. 2, dotted lines under −10V heading). This leads to a dark state of the image display 100 (see FIG. 1). When 0V or a positive voltage bias at the front electrode is applied, the positively charged particles 122 are moved away from the evanescent wave region where TIR of incident light rays lead to a bright state as the relative reflectance increases as shown by the dotted lines under the 0V heading in FIG. 2. Stability of the bright or light state may be maintained by voltage pulsing as described previously herein.

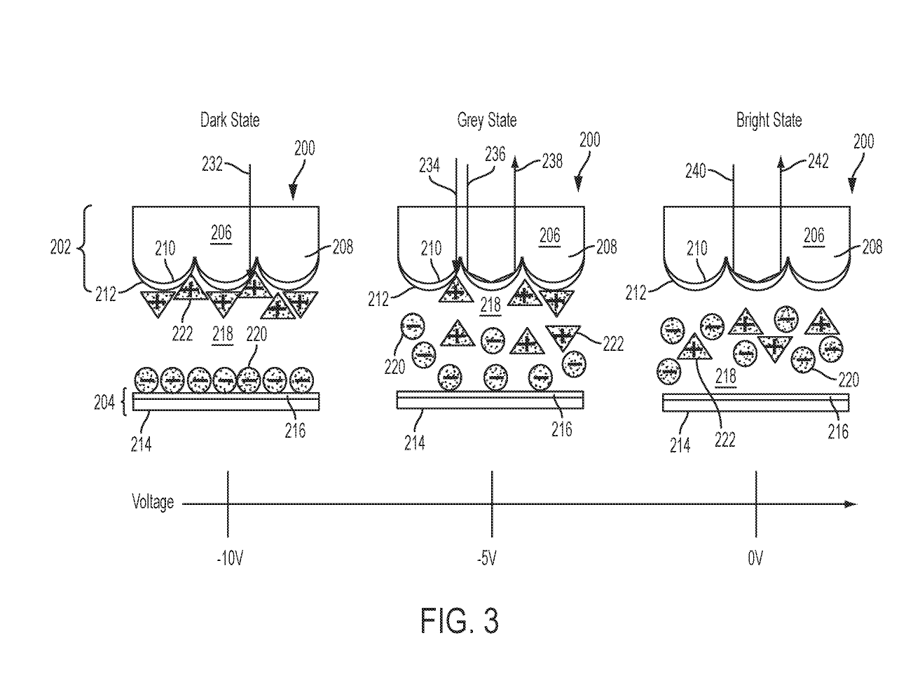

FIG. 3 schematically illustrates a method to create voltage bias dependent dark, grey and bright states in display 200. Image display 200 in FIG. 3 comprises oppositely-charged particles depicting black, white and grey states as illustrated with respect to display 100 of FIG. 1. Display 200 includes a top assembly 202 and bottom assembly 204 separated by a gap or cavity. A region of the gap (not shown) may define the evanescent region. In one embodiment, a region in the gap near the hemispherical surface is the evanescent region.

Top assembly 202 includes front sheet 206 having at least one surface structure such as a convex or hemispherical protrusion 208 capable of total internal reflection of light rays, front transparent electrode layer 210 positioned on the surface of the hemispherical protrusions and dielectric layer 212 positioned over front electrode layer 210. Though not shown, the dielectric layer may optionally be applied to the rear electrode. FIGS. 3A-3C show bottom assembly 204 in display 200 further including backplane 214 with top electrode layer 216 which acts as the rear electrode. Electrode layer 216 may include a thin film transistor (TFT) array, direct drive array or patterned array of electrodes. A liquid medium 218 may be located in the gap 218 interposed between top assembly 202 and bottom assembly 204. In one embodiment liquid medium 218 has a low refractive index. Medium 218 may include a plurality of dispersed light absorbing negatively charged particles 220 and a plurality of dispersed light absorbing positively charged particles 222. Display 200 may further include a voltage source (not shown).

The disclosed two particle TIR-based reflective display 200 is capable of producing DC balanced grey state levels. In the embodiment of FIG. 3, the bias (−10V) applied to front electrode layer 210 attracts positively charged particles 222 to front electrode 210 and dielectric layers 212 adjacent the contoured surface of the plurality of hemispherical protrusions 208. A substantial amount of particles 222 are able to frustrate TIR and create a dark or light absorbing state of image display 200. This is illustrated by representative light ray 232 being absorbed by charged particles 222. Negatively charged particles 220 collect at rear electrode 216 where the electrode is biased at +10V for DC balancing. It should be noted that −10V is for illustrative purposes only and this could be any other voltage where the required voltage strength is dependent on the density of charge on the particle surface and particle mobility.

As the applied voltage is decreased from −10V to −5V, for example, some of the positively charged particles 222 move out of the evanescent wave region. As a result, some of the light rays are absorbed. This state is schematically illustrated by representative light ray 234 being absorbed by particles 222. Additionally, some of the light rays are totally internally reflected as represented by incident light ray 236 that is totally internally reflected and emerges as reflected light ray 238. Thus, a reflective image comprising of grey states is created in display 200 when some of the light rays are absorbed and some are reflected at an intermediate applied voltage.

As the applied voltage approaches 0V, more light rays are totally internally reflected as an increasing amount of particles are moved out of the evanescent wave region. When 0V is reached, nearly all of the positively charged particles 222 may be out of the evanescent wave region resulting in a bright or white state of the display. This is illustrated by incident light ray 240 that is totally internally reflected and emerges as semi-retro-reflected light ray 242. In one embodiment, a continuum of grey state levels may be created by applying a non-zero voltage bias such as −10V down to 0V as illustrated in display 200 in FIG. 3. Voltage pulsing may also be employed to maintain a light or bright state as described herein.

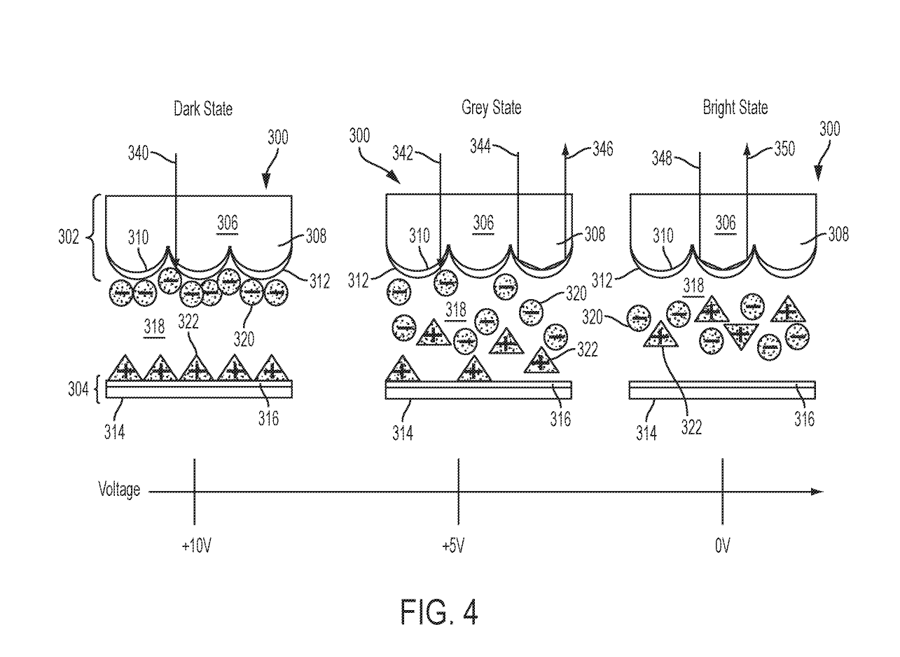

FIG. 4 schematically illustrates a method to create voltage bias dependent dark, grey and bright states in display 300. FIG. 4 further illustrates the continuum of possible grey states that is dependent on a continuum of applied voltage bias in a DC balanced system. Image display 300 in FIG. 4 contains oppositely-charged particles depicting black, white and grey states and is similar to display 100. Display 300 includes a top assembly 302 and bottom assembly 304 separated by a gap or cavity. The top assembly includes a front sheet 306 comprising at least one surface structure such as a convex or hemispherical protrusion 308 capable of total internal reflection of light rays, front transparent electrode layer 310 positioned on the surface of the hemispherical protrusions and dielectric layer 312 is positioned over front electrode layer 310. Display 300 also includes a bottom assembly 304 further including backplane 314 with top electrode layer 316 which acts as the rear electrode. Electrode layer 316 may include a thin film transistor (TFT) array, direct drive array or patterned array of electrodes. Though not shown, the dielectric layer may optionally be applied to the rear electrode. A liquid medium 318 may be located in the gap 318 interposed between top assembly 302 and bottom assembly 304. In one embodiment medium 318 may have a low refractive index. Medium 318 includes a plurality of dispersed light absorbing negatively charged particles 320 and a plurality of dispersed light absorbing positively charged particles 322. Display 300 may further include a voltage source (not shown).

The disclosed two particle TIR-based reflective display 300 is capable of producing DC balanced grey state levels. In this scenario, +10V may be applied at the front electrode such that substantially all of negatively charged particles 320 may collect near the surface of dielectric layer 312 adjacent front electrode 310 and plurality of hemispheres 308. Substantially all incident light rays are absorbed to create a dark state of the display. This is illustrated wherein representative incident light ray 340 is absorbed by the negatively charged particles 320. The positively charged particles 322 collect at the rear electrode where −10V is applied for DC balancing. As the applied voltage is decreased to, for example, +5V an increasing amount or continuum of negatively charged particles 320 are moved out of the evanescent wave region. As a result some incident light rays such as representative light ray 342 are absorbed by light absorbing particles 320 remaining at the surface while some light rays are totally internally reflected, such as representative incident light ray 344 that emerges as semi-retro-reflected light ray 346. This mixture of absorbed and totally internally reflected light rays results in a DC balanced grey state. As the applied voltage further decreases to 0V, all particles are moved out of and away from the evanescent wave region. The particle movement leads to substantially all incident light rays being totally internally reflected to create a light state. This is illustrated by representative incident light ray 348 that emerges as a semi-retro-reflected light ray 350. The light state may be maintained by voltage pulsing as described herein.

The embodiments of FIGS. 1, 3 and 4 provided a two particle TIR-based DC balanced reflective image display where particles of different charge but same optical characteristics (e.g. black) were attracted to oppositely-charged electrodes. The display in FIGS. 3 and 4 are exemplary embodiments capable of exhibiting black, white and a continuum of possible grey states. The embodiments of FIGS. 1, 3 and 4 may also be compatible with conventional LCD drive electronics.

In another embodiment, any of the two-particle total internal reflection image displays 100, 200 and 300 illustrated in FIG. 1, 3 or 4 may further include a color filter array. The color filter array may include red, blue, green or cyan, magenta, yellow sub-pixels.

In another embodiment, any of the two-particle total internal reflection image displays 100, 200 and 300 illustrated in FIG. 1, 3 or 4 may further include a thin film transistor array or direct drive array or a patterned array of electrodes or a combination thereof.

In another embodiment, any of the two-particle total internal reflection image displays 100, 200 and 300 illustrated in FIG. 1, 3 or 4 may further include a directional front light. The directional front light may further include a light source, light guide, an array of light extractor elements or a combination thereof. The light source may be a light emitting diode (LED), cold cathode fluorescent lamp (CCFL) or a surface mount technology (SMT) incandescent lamp.

In another embodiment, any of the two-particle total internal reflection image displays 100, 200 and 300 illustrated in FIG. 1, 3 or 4 may further include at least one spacer structure to control the gap spacing between the top and bottom assemblies. The spacer structures may be in the form of, but not limited to, spheres, beads, cubes, cylinders, or prisms. The spacer structures may be comprised of, but not limited to, polymer, glass, metal or other organic or inorganic materials.

In another embodiment, any of the two-particle total internal reflection image displays 100, 200 and 300 illustrated in FIG. 1, 3 or 4 may further include cross-walls. Cross-walls may be used to create wells or compartments within the display to confine the particles and medium to prevent particle migration or settling. The wells or compartments may be in the shape of circles, ovals, squares, rectangles, diamonds in regular or irregular arrays. The cross-walls may consist of glass, a polymer or other organic or inorganic-based material.

In another embodiment, any of the two-particle total internal reflection image displays 100, 200 and 300 illustrated in FIG. 1, 3 or 4 may further include at least one edge seal. An edge seal may be used along at least one edge of the display. The sealant used to form the edge seal may be a thermally or photochemically cured material. The edge seal may contain an epoxy, silicone or other polymer based material.

In other embodiments, any of the two-particle total internal reflection image displays 100, 200 and 300 illustrated in FIG. 1, 3 or 4 may further include a thin film transistor or patterned or direct drive array, a directional front light, a color filter array, at least one spacer structure or cross-walls, at least one edge seal or a combination thereof.

The disclosed embodiments are not limited to the dark, light and grey states. In another embodiment, the two-particle reflective image may be modified to create a multi-colored display without the need of a color filter array. For example, the negatively charged particles may be of a first optical characteristic (i.e. color), such as red. The positively charged particles may be of a second optical characteristic, such as black. A third white optical state may be created from total internal reflection of incident light rays at the surface of the plurality of convex or hemispherical protrusions.

Application of a positive voltage bias at the front electrode may attract the red negatively charged particles to the front surface to frustrate TIR and create a red image state. Application of a negative voltage bias at the front electrode may attract the black positively charged particles to the front surface to frustrate TIR and create a black image state. Application of 0V may cause the particles to move out of the evanescent wave region and allow incident light rays to totally internally reflect to create a bright or white image state. A variety of different colored particles may be used that are not limited to red and black as described.

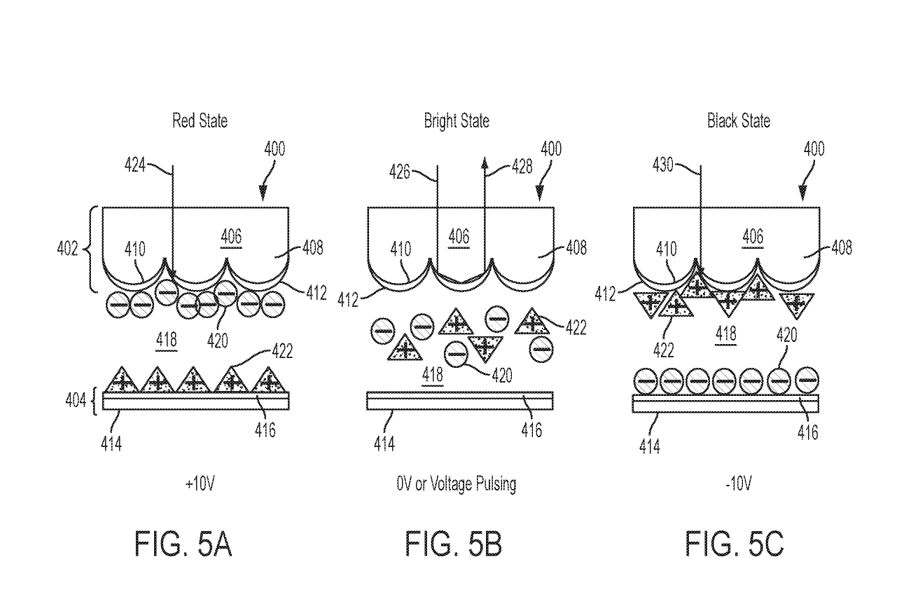

FIG. 5A-5C schematically illustrates a display having charged particles of different optical characteristics in various states of operation. Specifically, FIGS. 5A-5C depicts a portion of the TIR-based display 400 in a DC balanced mode in various states of operation. The design of image display 400 is substantially similar to display 100 of FIGS. 1A-1C, but instead contains both a first plurality of positively charged particles of a first optical characteristic and a second plurality of negatively charged particles of a second optical characteristic. In one embodiment, the magnitude of the electrophoretic mobility and diffusivity may be substantially similar for both the positive and negative particles of different optical characteristics. This can lead to an image response that is similar for both polarities in order to ensure that the particles would behave in a similar way with the magnitude of the applied voltage.

Display 400 includes a top assembly 402 and bottom assembly 404 separated by a gap or cavity. The top assembly includes a front sheet 406 further including at least one surface structure such as a convex or hemispherical protrusion 408 capable of total internal reflection of light rays, front transparent electrode layer 410 positioned on the surface of the hemi-spherical protrusions and dielectric layer 412 positioned over front electrode layer 410. FIGS. 5A-5C include bottom assembly 404 having backplane 414 with top electrode layer 416 which acts as the rear electrode. Electrode layer 416 may include a thin film transistor (TFT) array, direct drive array or patterned array of electrodes. Though not shown, the dielectric layer may optionally be applied to the rear electrode. A liquid medium 418 of low refractive index may be located in the gap 418 interposed between top assembly 402 and bottom assembly 404. Medium 418 includes a plurality of dispersed light absorbing negatively charged particles 420 of a first optical characteristic and a plurality of dispersed light absorbing positively charged particles 422 of a second optical characteristic. Particles 420, 422 of different optical characteristics may be made of an organic material or an inorganic material or a combination of an organic and inorganic material. Particles 420, 422 may be capable of being electrophoretically moved by application of an electric field across the medium 418 by an external voltage source (not shown). While shown with particles of two optical characteristics, the disclosed principles may be used with particles of more than two (multiple) optical characteristics and the disclosed embodiments are not limited to particles having only two optical characteristics.

Upon application of a positive voltage bias such as +10V, for example, as depicted in FIG. 5A at the front electrode layer 410, the negatively charged particles 420 of first optical characteristic, such as red, are attracted to the front electrode 410 and dielectric layer 412. At this location adjacent the plurality of hemispheres 408, TIR is frustrated leading to a decrease in relative reflectance. The positively charged electrophoretically mobile particles 422 of a second optical characteristic, such as black, are attracted to and move towards the rear electrode layer 416 which has a voltage bias of −10V. As a result, TIR is frustrated and incident light rays such as representative light ray 424 are absorbed by the negatively charged particles located at the front dielectric layer 412. This creates a first optical state of the image display of same color (such as for example, red) as the optical characteristic of the negatively charged particles 420.

FIG. 5B depicts the application of 0V resulting in a bright or white optical state of the display. At zero applied voltage the negatively charged electrophoretically mobile particles 420 are substantially moved away from the evanescent wave region near the surface of the plurality of hemispherical protrusions 408. This allows total internal reflection of light rays to occur leading to a white or bright state of the image display. This is illustrated by incident light ray 426 being totally internally reflected as light ray 428 is semi-retro-reflected back towards the light source. Additionally, the positively charged particles 422 will be attracted away from the rear electrode layer 416. The white or bright state may be maintained by moving the particles out of the evanescent wave region with an appropriate voltage and duration of time followed by voltage pulsing as described previously herein.

When applying a negative voltage bias such as −10V at the front electrode layer as shown in FIG. 5C, the positively charged electrophoretically mobile particles 422 of a second optical characteristic, such as black, and different from the first optical characteristic of the negatively charged particles 420 are attracted to and move towards front electrode 410 and dielectric layer 412. At this location the positively charged particles 422 are adjacent the surface of the plurality of hemispheres 408 such that the particles enter the evanescent wave region. As a result TIR is frustrated and incident light rays, such as representative light ray 430, are absorbed by the positively charged particles 422 of a second optical characteristic located at the front dielectric layer 412. This creates a second optical state of the image display that appears black to the viewer viewing the display. Additionally, the negatively charged particles 420 are attracted to the rear electrode layer 416. When applying a non-zero voltage bias (e.g., +10V or −10V) across the medium 418 as shown in FIGS. 5A and 5C, particles are both attracted to the front and rear electrode layers. This not only results in frustration of TIR and leading to a multi-colored reflective image display of at least three different colors, but it also may lead to a DC balanced display. This display 400 which is capable of exhibiting multiple colors may also be compatible with existing LCD drive electronics.

Display 400 of FIGS. 5A-5C may also exhibit a variety of DC balanced optical states (i.e., colors) resulting from the mixing of the different optical states of the positively and negatively charged particles. This may be done by applying a continuum of voltage biases.

In other embodiments, the two-particle total internal reflection image display 400 illustrated in FIG. 5 may further include a thin film transistor (TFT) array, or a direct drive array or a patterned array of electrodes.

In another embodiment the two-particle total internal reflection image display 400 illustrated in FIG. 5 may further include a directional front light.

In another embodiment the two-particle total internal reflection image display 400 illustrated in FIG. 5 may further include at least one spacer structure.

In another embodiment the two-particle total internal reflection image display 400 illustrated in FIG. 5 may further include cross-walls.

In another embodiment the two-particle total internal reflection image display 400 illustrated in FIG. 5 may further include at least one edge seal.

In other embodiments, display 400 may further include any combination of a thin film transistor array, a direct drive array, a patterned array, a directional front light, at least one spacer structure or cross-walls, at least one edge seal or a combination thereof.

In the display embodiments described herein, they may be used in applications such as in, but not limited to, electronic book readers, portable computers, tablet computers, wearables, cellular telephones, smart cards, signs, watches, shelf labels, flash drives and outdoor billboards or outdoor signs.

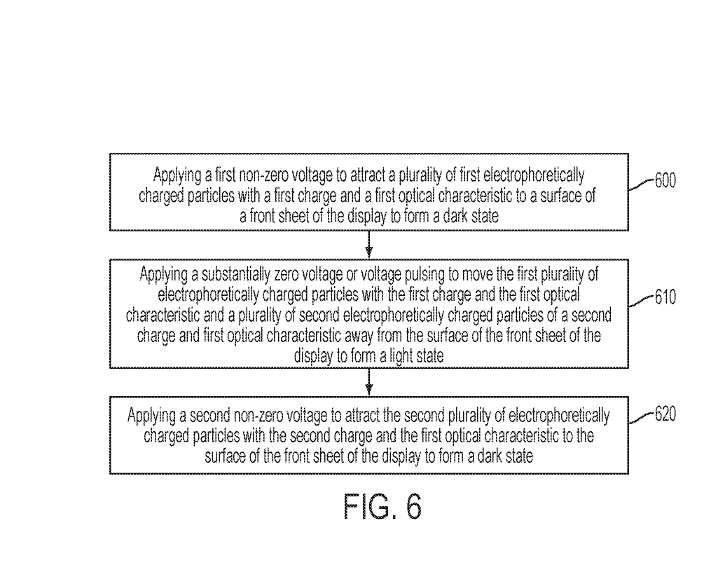

FIG. 6 is an exemplary method according to an embodiment of the disclosure. The embodiment of FIG. 6 may be implemented at a display such as those disclosed in relation to FIGS. 1, 3-5. The method of FIG. 6 begins at step 600 by applying a first non-zero voltage to attract a plurality of first electrophoretically charged particles with a first charge and a first optical characteristic to a surface of a front sheet of the display to form a dark state.

At step 610, a substantially zero voltage or voltage pulsing is applied to move the first plurality of electrophoretically charged particles with the first charge and the first optical characteristic and a plurality of second electrophoretically charged particles of a second charge and first optical characteristic away from the surface of the front sheet of the display to form a light state. The first particles may be different from the second particles or the first and the second particles may define substantially the same particles. In an alternative embodiment, step 610 may comprise applying a substantially zero voltage or voltage pulsing to move the first plurality of electrophoretically charged particles with the first charge and the first optical characteristic and a plurality of second electrophoretically charged particles with an opposite charge and a second optical characteristic away from the surface of the front sheet of the display to form a light state.

At step 620, a second, non-zero voltage is applied to attract the second plurality of electrophoretically charged particles with the second charge and the first optical characteristic to the surface of the front sheet of the display to form a dark state. In an alternative embodiment, step 620 may comprise applying a second non-zero voltage to attract the second plurality of electrophoretically charged particles with the second charge and the first optical characteristic to the surface of the front sheet of the display to form a dark state.

The following non-limiting embodiments further illustrate embodiments of the disclosure. Example 1 is directed to a totally internally reflective (TIR) image display, comprising: a front assembly having a front sheet, a front electrode and a dielectric layer, the front electrode interposed between the front sheet and the dielectric layer, the front sheet further including at least one convex protrusion; a back assembly forming a gap with the front assembly, the back assembly having a back plane and a rear electrode, the rear electrode positioned opposite the dielectric layer; a low refractive index medium in the gap; and a plurality of electrophoretically mobile positively charged particles and a plurality of electrophoretically mobile negatively charged particles dispersed in the low refractive index medium.

Example 2 is directed to the display of example 1, wherein the rear electrode further comprises a thin film transistor array, a direct drive array or a patterned array of electrodes or a combination thereof.

Example 3 is directed to the display of example 2, further comprising cross-walls.

Example 4 is directed to the display of any preceding example, further comprising a spacer structure.

Example 5 is directed to the display of any preceding example, wherein the back assembly further comprises a dielectric layer on the rear electrode.

Example 6 is directed to the display of any preceding example, further comprising a directional front light.

Example 7 is directed to the display of any preceding example, further comprising a color filter layer.

Example 8 is directed to the display of any preceding example, further comprising an edge seal.

Example 9 is directed to the display of any preceding example, further comprising cross-walls and an edge seal and a directional front light.

Example 10 is directed to the display of any preceding example, wherein the convex portion defines a hemispherical structure.

Example 11 is directed to the display of any preceding example, wherein the convex portion defines a structure configured to uniformly distribute the plurality of negatively or positively charged particles.

Example 12 is directed to the display of any preceding example, wherein the plurality of electrophoretically mobile positively charged particles are of a first optical characteristic and the plurality of electrophoretically mobile negatively charged particles are of a second optical characteristic.

Example 13 is directed to the display of any preceding example, further comprising cross-walls.

Example 14 is directed to the display of any preceding example, further comprising a spacer structure.

Example 15 is directed to the display of any preceding example, wherein the back assembly further comprises a dielectric layer on the rear electrode.

Example 16 is directed to the display of any preceding example, further comprising a directional front light.

Example 17 is directed to the display of any preceding example, further comprising a spacer structure, an edge seal and a directional front light.

Example 18 is directed to the display of any preceding example, further comprising cross-walls, an edge seal and a directional front light.

Example 19 is directed to a method for switching a totally internally reflective image display from a dark state to a light state, comprising: applying a first non-zero voltage to attract a plurality of first electrophoretically charged particles with a first charge and a first optical characteristic to a surface of a front sheet of the display to form a dark state; applying a substantially zero voltage or voltage pulsing to move the first plurality of electrophoretically charged particles with the first charge and the first optical characteristic and a plurality of second electrophoretically charged particles of a second charge and first optical characteristic away from the surface of the front sheet of the display to form a light state; and applying a second non-zero voltage to attract the second plurality of electrophoretically charged particles with the second charge and the first optical characteristic to the surface of the front sheet of the display to form a dark state.

Example 20 is directed to a method for switching a totally internally reflective image display from a first optical state to a light state to a second optical state, comprising: applying a first non-zero voltage to attract a first plurality of electrophoretically charged particles with a first charge and a first optical characteristic to the surface of the front sheet of the display to form a first optical state; applying a substantially zero voltage or voltage pulsing to move the first plurality of electrophoretically charged particles with the first charge and the first optical characteristic and a plurality of second electrophoretically charged particles with an opposite charge and a second optical characteristic away from the surface of the front sheet of the display to form a light state; and applying a second non-zero voltage to attract a plurality of electrophoretically charged particles with a second charge and second optical characteristic to the surface of the front sheet of the display to form a second optical state.

Example 21 relates to a totally internally reflective (TIR) image display, comprising: a front assembly having a front sheet, a front electrode, the front sheet further including at least one convex protrusion; a back assembly forming a gap with the front assembly, the back assembly having a back plane and a rear electrode, the rear electrode positioned opposite the dielectric layer; a low refractive index medium in the gap; and a plurality of electrophoretically mobile positively charged particles and a plurality of electrophoretically mobile negatively charged particles dispersed in the low refractive index medium.

While the principles of the disclosure have been illustrated in relation to the exemplary embodiments shown herein, the principles of the disclosure are no limited thereto and include any modification, variation or permutation thereof.

1. A totally internally reflective (TIR) image display, comprising:
a front assembly having a front sheet, a front electrode and a dielectric layer, the front electrode interposed between the front sheet and the dielectric layer, the front sheet further including at least one convex protrusion;
a back assembly forming a gap with the front assembly, the back assembly having a back plane and a rear electrode, the rear electrode positioned opposite the dielectric layer;
a low refractive index medium in the gap; and
a plurality of electrophoretically mobile positively charged particles and a plurality of electrophoretically mobile negatively charged particles dispersed in the low refractive index medium.

2. The totally internally reflective image display according to claim 1, wherein the rear electrode further comprises a thin film transistor array, a direct drive array or a patterned array of electrodes or a combination thereof.

3. The totally internally reflective image display according to claim 2, further comprising cross-walls.

4. The totally internally reflective image display according to claim 2, further comprising a spacer structure.

5. The totally internally reflective image display according to claim 2, wherein the back assembly further comprises a dielectric layer on the rear electrode.

6. The totally internally reflective image display according to claim 2, further comprising a directional front light.

7. The totally internally reflective image display according to claim 6, further comprising a color filter layer.

8. The totally internally reflective image display according to claim 7, further comprising an edge seal.

9. The totally internally reflective image display according to claim 2, further comprising cross-walls and an edge seal and a directional front light.

10. The totally internally reflective image display according to claim 1, wherein the convex portion defines a hemispherical structure.

11. The totally internally reflective image display according to claim 1, wherein the convex portion defines a structure configured to uniformly distribute the plurality of negatively or positively charged particles.

12. The totally internally reflective image display according to claim 2, wherein the plurality of electrophoretically mobile positively charged particles are of a first optical characteristic and the plurality of electrophoretically mobile negatively charged particles are of a second optical characteristic.

13. The totally internally reflective image display according to claim 1, further comprising cross-walls.

14. The totally internally reflective image display according to claim 1, further comprising a spacer structure.

15. The totally internally reflective image display according to claim 1, wherein the back assembly further comprises a dielectric layer on the rear electrode.

16. The totally internally reflective image display according to claim 1, further comprising a directional front light.

17. The totally internally reflective image display according to claim 1, further comprising a spacer structure, an edge seal and a directional front light.

18. The totally internally reflective image display according to claim, further comprising cross-walls, an edge seal and a directional front light.

19. A method for switching a totally internally reflective image display from a dark state to a light state, comprising:
applying a first non-zero voltage to attract a plurality of first electrophoretically charged particles with a first charge and a first optical characteristic to a surface of a front sheet of the display to form a dark state;
applying a substantially zero voltage or voltage pulsing to move the first plurality of electrophoretically charged particles with the first charge and the first optical characteristic and a plurality of second electrophoretically charged particles of a second charge and first optical characteristic away from the surface of the front sheet of the display to form a light state; and
applying a second non-zero voltage to attract the second plurality of electrophoretically charged particles with the second charge and the first optical characteristic to the surface of the front sheet of the display to form a dark state.

20. A method for switching a totally internally reflective image display from a first optical state to a light state to a second optical state, comprising:
applying a first non-zero voltage to attract a first plurality of electrophoretically charged particles with a first charge and a first optical characteristic to the surface of the front sheet of the display to form a first optical state;
applying a substantially zero voltage or voltage pulsing to move the first plurality of electrophoretically charged particles with the first charge and the first optical characteristic and a plurality of second electrophoretically charged particles with an opposite charge and a second optical characteristic away from the surface of the front sheet of the display to form a light state; and
applying a second non-zero voltage to attract a plurality of electrophoretically charged particles with a second charge and second optical characteristic to the surface of the front sheet of the display to form a second optical state.

21. A totally internally reflective (TIR) image display, comprising:
a front assembly having a front sheet, a front electrode, the front sheet further including at least one convex protrusion;
a back assembly forming a gap with the front assembly, the back assembly having a back plane and a rear electrode, the rear electrode positioned opposite the front electrode;
a low refractive index medium in the gap; and
a plurality of electrophoretically mobile positively charged particles and a plurality of electrophoretically mobile negatively charged particles dispersed in the low refractive index medium.
